(19) United States
(12) Patent Application Publication
(10) Pub. No.: US 2013/0136934 A1
(43) Pub. Date: May 30, 2013

(54) PROCESS FOR PRODUCING POLYIMIDE FILM, POLYIMIDE FILM AND LAMINATE COMPRISING THE SAME

(71) Applicants: Hideki Iwai, Ube-shi (JP); Jin Kobayashi, Ube-shi (JP); Youhei Oosumi, Ube-shi (JP); Tatsushi Nakayama, Ube-shi (JP)

(72) Inventors: Hideki Iwai, Ube-shi (JP); Jin Kobayashi, Ube-shi (JP); Youhei Oosumi, Ube-shi (JP); Tatsushi Nakayama, Ube-shi (JP)

(73) Assignee: UBE INDUSTRIES, LTD., Ube-shi (JP)

(21) Appl. No.: 13/698,875

(22) PCT Filed: May 19, 2011
(86) PCT No.: PCT/JP2011/061576

§ 371 Date: Jan. 25, 2013

(30) Foreign Application Priority Data
May 20, 2010 (JP) 2010-116648

(51) Int. Cl. B32B 15/08

(52) U.S. Cl. CPC B32B 15/08
USPC 428/458; 528/353; 264/216

(57) ABSTRACT

The present invention relates to a polyimide film prepared from a tetracarboxylic acid component and a diamine component, wherein the strength of orientation anisotropy in the film length of 2000 mm is 1.2 or less and/or the strength of orientation anisotropy in the film length of 1800 mm is 1.1 or less.

### TECHNICAL FIELD

The present invention relates to a polyimide film to provide a laminate of polyimide film and another material such as metal which has an improved slanting warping; a process for producing the same; and a laminate of polyimide film and metal which has an improved slanting warping.

### BACKGROUND ART

A polyimide film has been widely used in various applications such as the electric/electronic device field and the semiconductor field, because it has excellent heat resistance, chemical resistance, mechanical strength, electric properties, dimensional stability and the like. For example, a polyimide film is used as a base film for a circuit board, a base film for a flexible wiring board, and the like.

One example of the polyimide films suitable for the applications is a polyimide film disclosed in Patent Document 1, which is prepared from an aromatic tetracarboxylic acid component comprising 3,3′,4,4′-biphenyltetracarboxylic dianhydride as the main component and an aromatic diamine component comprising p-phenylenediamine as the main component.

Patent Document 2 discloses a process for producing a polyimide film in which the coefficient of thermal expansion in the width direction is lower than the coefficient of thermal expansion in the length direction, which comprises steps of:

flow-casting a solution of a polyimide precursor in a solvent on a support,

removing the solvent from the solution, to form a self-supporting film;

stretching the self-supporting film in the width direction at an initial heating temperature of from 80° C. to 300° C.; and then
heating the film at a final heating temperature of from 350° C. to 580° C.

In the Examples of Patent Document 2, the polyimide films were prepared by stretching the self-supporting films by drawing the fixing members to fix both edges of the films in the width direction at a constant speed and a constant rate during the initial heating, while heating the films under the temperature conditions [1] (105° C.×1 min-150° C.×1 min-280° C.×1 min), or alternatively, the temperature conditions [2] (105° C.×1 min-150° C.×1 min-230° C.×1 min) as the initial heating temperature, and then heating the films at 350° C.×2 min as the final heating temperature without stretching to achieve the completion of imidization.

Patent Document 3 discloses an adhesive film in which an adhesive layer comprising a thermoplastic polyimide is formed on at least one side of a polyimide film, wherein the adhesive film has a width of 250 mm or more and a degree of orientation in the full-width of 1.3 or less. In the Examples of Patent Document 3, the polyimide films were produced by the processes in which continuously both edges of the film were fixed to pin-seats, and then the distance (width) between the both edges of the film was enlarged to 104.5% or 100.5% based on the distance at the film-fixing point before the film was fed into a heating oven in which the temperature of the inlet was 250° C. or 200° C., and the distance (width) was constant after that. Meanwhile, in the Comparative Example 1, the polyimide film was produced by the process in which the distance (width) between the both edges of the film was not enlarged before the film was fed into a heating oven in which the temperature of the inlet was 150° C., and the film width was constant while the film was conveyed in the heating oven.

Patent Document 4 discloses a polyimide film which has a width of 500 mm or more, and has a maximum MOR-c (which is an index of the state of the molecular orientation) of 1.35 or less and a tensile modulus of elasticity of 5.0 GPa or more at every point in the film. In the Examples and Comparative Examples of Patent Document 4, the polyimide films were produced by the processes in which the self-supporting green sheet of which both edges were fixed to pin-seats was fed into a heating oven, and the film was conveyed, while keeping the film width constant, from the fixing of the film to the pins till the separation of the film from the pins after the heating. In the Comparative Examples 1 and 3, both edges of the green sheet were fixed to pin-seats, and the film was heated at 200° C. for 30 sec in this state, and then the film was successively fed into heating ovens at 350° C., 450° C. and 500° C. and heated for about 30 sec in each heating oven.

Patent Document 5 discloses a process for continuously producing a polyimide film, in which the film (self-supporting film; green sheet) comprising at least one volatile component, or being in a state to undergo a reaction involving film shrinkage by the application of heat is conveyed through a heating oven and heated, while fixing both edges of the film, whereby drying and curing the film, wherein the distance between the starting point of the heating and the film-fixing point (the distance from the point at which both edges of the green sheet are fixed to the point at which the green sheet is fed into a heating oven) is equal to or greater than the film width. In the Examples of Patent Document 5, the polyimide films were produced by the processes in which the green sheet was fed into a heating oven at 150° C. first after both edges of the green sheet were fixed.

### CITATION LIST

### Patent Document

Patent document 1; JP-B-H06-002828
Patent document 2: JP-A-2009-067042
Patent document 3: WO 2006/82828 A1
Patent document 4: JP-A-2002-154168
Patent document 5: JP-A-H08-81571

### SUMMARY OF INVENTION

### Problems to be Solved by the Invention

However, a lamination of a polyimide film produced by a conventional production process with another material such as metal sometimes provides a laminate having a slanting warping.

An objective of the present invention is to provide a polyimide film capable of providing a laminate of polyimide film and another material such as metal which has an improved slanting warping; and a process for producing the polyimide film. Another objective of the present invention is to provide a laminate of polyimide film and metal which has an improved slanting warping.

### Means for Solving the Problems

The present invention relates to the following items.

(1) A process for producing a polyimide film, comprising steps of:

reacting a tetracarboxylic acid component and a diamine component in a solvent, to provide a polyimide precursor solution;

flow-casting the polyimide precursor solution on a support, and drying the solution to form a self-supporting film; and

heating the self-supporting film in a heating oven, while fixing both edges of the film in the width direction with fixing members, to provide a polyimide film; wherein

the temperature of the inlet of the heating oven is 180° C. or higher; and

the self-supporting film is heated without changing the distance between the fixing members at both edges of the film in at least a portion of the temperature range of from 180° C. to 220° C. in the heating oven; and then

the self-supporting film is stretched in the width direction by changing the distance between the fixing members at both edges of the film in at least a portion of the temperature range of higher than 220° C. in the heating oven.

(2) A process for producing a polyimide film as described in (1), wherein the self-supporting film is heated without changing the distance between the fixing members at both edges of the film throughout the temperature range of from 180° C. to 220° C. in the heating oven.

(3) A process for producing a polyimide film as described in (1), wherein the self-supporting film is heated for 1 min or less, excluding 0, in the temperature range of from 180° C. to 220° C. in the heating oven.

(4) A process for producing a polyimide film as described in (1), wherein the self-supporting film is heated for 1 min or less, excluding 0, without changing the distance between the fixing members at both edges of the film throughout the temperature range of from 180° C. to 220° C. in the heating oven.

(5) A polyimide film prepared from a tetracarboxylic acid component and a diamine component; wherein

the strength of orientation anisotropy in the film length of 2000 mm is 1.2 or less.

(6) A polyimide film prepared from a tetracarboxylic acid component and a diamine component; wherein

the strength of orientation anisotropy in the film length of 1800 mm is 1.1 or less.

(7) A polyimide film as described in (5) or (6), wherein the tetracarboxylic acid component is 3,3′,4,4′-biphenyltetracarboxylic dianhydride, and the diamine component is p-phenylenediamine.

(8) A laminate comprising a polyimide film as described in any one of (5) to (7), and a metal which is laminated on the polyimide film.

### Effect of the Invention

A laminate having an adequately reduced slanting warping may be prepared by laminating another material such as metal on a polyimide film wherein the strength of orientation anisotropy in the film length of 2000 mm is 1.2 or less, or alternatively, a polyimide film wherein the strength of orientation anisotropy in the film length of 1800 mm is 1.1 or less. The term “strength of orientation anisotropy” as used herein is the ratio of the maximum value to the minimum value of the speed of sound in every direction, which is measured at a certain point in the film plane. In general, the strength of orientation anisotropy tends to be greater and greater toward the edge of the film, and therefore the strength of orientation anisotropy at the edge of the film is the maximum value of the strength of orientation anisotropy in the film.

There have been no polyimide films having so great width and so small orientation anisotropy in the full-width. When a polyimide film is produced by heating a self-supporting film, while fixing both edges of the film, according to a conventional method of production, the molecular orientation tends to proceed highly at the edge of the film, in particular, and therefore the strength of orientation anisotropy tends to be greater and greater toward the edge of the film. Consequently, in a polyimide film having greater width, in particular, the strength of orientation anisotropy at the edge of the film may be extremely great. The greater strength of orientation anisotropy may cause variations in the properties such as coefficient of thermal expansion (CTE) in the oblique direction and elastic modulus, resulting in unevenness of tension during processing/transportation, sagging and unevenness of thermal expansion during heating, slanting warping, particularly slanting warping in the laminate of polyimide film and another material such as metal, and reduction of dimensional accuracy in processing. Accordingly, a laminate having a slanting warping may be prepared by laminating another material such as metal on a polyimide film produced by a conventional production process.

According to the present invention, a polyimide film having a reduced strength of orientation anisotropy may be prepared by setting the initial heating temperature at 180° C. or higher, which is higher than usual, and heating the self-supporting film without changing the distance between the fixing members at both edges of the film in at least a portion of the temperature range of from 180° C. to 220° C., which is the initial heating step, in the step of heating the self-supporting film to provide a polyimide film. Additionally, as described above, when using the polyimide film, a laminate having an adequately reduced slanting warping may be prepared.

In addition, it is preferred that a self-supporting film is stretched at least in the width direction in the heating step except the initial heating step during imidization, preferably in the temperature range of higher than 220° C. in the heating oven, so as to control the coefficient of thermal expansion of the obtained polyimide film to be within a desired range. There is a tendency to provide a laminate having a slanting warping more frequently when a coefficient of thermal expansion of the polyimide film is significantly different from that of another material such as metal to be laminated thereon. Accordingly, the coefficient of thermal expansion of the polyimide film may be preferably controlled to be close to that of another material such as metal to be laminated thereon. According to the present invention, however, it is preferred that a self-supporting film is not stretched in the initial heating step during the heat treatment for imidization, nor before the heat treatment for imidization, as described above.

### BRIEF DESCRIPTION OF THE DRAWINGS

FIG. 1 illustrates the results of the measurements of the strength of orientation anisotropy in the polyimide films prepared in the Examples and Comparative Examples.

FIG. 2 illustrates the results of the measurements of the orientation angle in the polyimide films prepared in the Examples and Comparative Examples.

### DESCRIPTION OF EMBODIMENTS

According to the present invention, the polyimide film is produced by

the first step of casting a polyimide precursor solution, which is prepared by reacting a tetracarboxylic acid component and a diamine component in a solvent, on a support, and forming a self-supporting film from the solution; and

the second step (curing step) of heating the self-supporting film to complete the imidization.

The self-supporting film is generally stretched in the width direction from the middle of the second step so as to achieve a desired coefficient of thermal expansion. According to the present invention, in the second step, the initial heating temperature is set at 180° C. or higher, which is higher than usual, and the self-supporting film is heated without changing the distance between the fixing members at both edges of the film in the initial heating step, preferably in the heating temperature range of from 180° C. to 220° C., whereby allowing the reduction in the strength of orientation anisotropy. Accordingly, there may be provided a polyimide film, on which another material such as metal may be laminated to provide a laminate having an improved slanting warping.

A self-supporting film is in a semi-cured state, or in a dried state which is an earlier stage. The term “in a semi-cured state, or in a dried state which is an earlier stage” means that the film is in a self-supporting state by heating and/or chemical imidization. The self-supporting film is any film which may be peeled off from the support, and the self-supporting film may have any solvent content (weight loss on heating) and any imidization rate. The solvent content and the imidization rate of the self-supporting film may be appropriately determined depending on the polyimide film intended to be produced.

Examples of the process of imidization in the second step include thermal imidization, chemical imidization, and a combination of thermal imidization and chemical imidization, as described below.

### (1) Thermal Imidization

A polyamic acid solution, or a polyamic acid solution composition which is prepared by adding, as necessary, an imidization catalyst, an organic phosphorous-containing compound, an inorganic fine particle and the like to a polyamic acid solution, is flow-cast on a support to form a film;

the solution or the composition is heated and dried to form a self-supporting film; and then

the polyamic acid is thermally dehydrative cyclized and the solvent is removed.

### (2) Chemical Imidization

A polyamic acid solution composition which is prepared by adding a cyclization catalyst and a dehydrating agent, and, as necessary, an inorganic fine particle and the like to a polyamic acid solution, is flow-cast on a support to form a film;

the polyamic acid is chemically dehydrative cyclized and, as necessary, the composition is heated and dried to form a self-supporting film; and then

the self-supporting film is heated for removing the solvent and imidizing the polyamic acid.

One example of the process for producing the polyimide film of the present invention is as follows. However, the production process is not limited to the following process.

<First Step>

A polyamic acid, which is a polyimide precursor, is synthesized by reacting a tetracarboxylic acid component and a diamine component. The reaction may be conducted in an organic solvent. And then, after adding an imidization catalyst, an organic phosphorous compound and/or an inorganic fine particle to the solution of the polyimide precursor thus obtained, if necessary, the solution is flow-cast on a support, and heated and dried to form a self-supporting film.

(Polyimide Precursor Solution)

Examples of the tetracarboxylic acid component include aromatic tetracarboxylic dianhydrides, aliphatic tetracarboxylic dianhydrides, and alicyclic tetracarboxylic dianhydrides. Specific examples of the tetracarboxylic acid component include aromatic tetracarboxylic dianhydrides such as 3,3′,4,4′-biphenyltetracarboxylic dianhydride (hereinafter, also referred to as “s-BPDA”), pyromellitic dianhydride (hereinafter, also referred to as “PMDA”), 3,3′,4,4′-oxydiphthalic dianhydride, diphenyl sulfone-3,4,3′,4′-tetracarboxylic dianhydride, bis(3,4-dicarboxyphenyl)sulfide dianhydride, and 2,2-bis(3,4-dicarboxyphenyl)-1,1,1,3,3,3-hexafluoropropane dianhydride. Among others, s-BPDA is suitably used as the tetracarboxylic acid component.

Examples of the diamine component include aromatic diamines, aliphatic diamines, and alicyclic diamines. Specific examples of the diamine component include aromatic diamines such as p-phenylenediamine (hereinafter, also referred to as “PPD”), 4,4′-diaminodiphenyl ether (hereinafter, also referred to as “DADE”), 3,4′-diaminodiphenyl ether, in-tolidine, p-tolidine, 5-amino-2-(p-aminophenyl)benzoxazole, 4,4′-diaminobenzanilide, 1,3-bis(4-aminophenoxy)benzene, 1,4-bis(3-aminophenoxy)benzene, 1,4-bis(4-aminophenoxy)benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, 2,2-bis[3-(3-aminophenoxy)phenyl]propane, 2,2-bis[3-(4-aminophenoxy)phenyl]propane, 2,2-bis[4-(3-aminophenoxy)phenyl]propane, and 2,2-bis[4′(4-aminophenoxy)phenyl]propane. Among others, PPD and DADE are suitably used as the diamine component.

Examples of the combination of the tetracarboxylic acid component and the diamine component include the following combinations (1) to (3), which may easily provide films having excellent mechanical properties, high rigidity and excellent dimensional stability, and may be suitably used for various substrate, including a substrate for a circuit board. Among others, (1) and (2) are particularly preferred, and (1) is more preferred.

(1) Combination of 3,3′,4,4′-biphenyltetracarboxylic dianhydride, and p-phenylenediamine or, alternatively, p-phenylenediamine and 4,4′-diaminodiphenyl ether (the ratio of PPD/DADS (molar ratio) may be preferably 100/0 to 85/15, for example.).

(2) Combination of 3,3′,4,4′-biphenyltetracarboxylic dianhydride and pyromellitic dianhydride (the ratio of s-BPDA/PMDA (molar ratio) may be preferably 99/1 to 0/100, more preferably 97/3 to 70/30, particularly preferably 95/5 to 80/20, for example.), and p-phenylenediamine or, alternatively, p-phenylenediamine and 4,4′-diaminodiphenyl ether (the ratio of PPD/DADE (molar ratio) may be preferably 90/10 to 10/90, for example.).

(3) Combination of pyromellitic dianhydride, and p-phenylenediamine and 4,4′-diaminodiphenyl ether (the ratio of PPD/DADE (molar ratio) may be preferably 90/10 to 10/90, for example.).

The polyimide precursor may be particularly preferably prepared from a tetracarboxylic acid component comprising 3,3′,4,4′-biphenyltetracarboxylic dianhydride as the main component, and a diamine component comprising p-phenylenediamine as the main component. More specifically, the preferable tetracarboxylic acid component may comprise 70 mol % or more, more preferably 80 mol % or more, particularly preferably 90 mol % or more, further preferably 95 mol % or more of s-BPDA, and the preferable diamine component may comprise 70 mol % or more, more preferably 80 mol % or more, particularly preferably 90 mol % or more, further preferably 95 mol % or more of PPD. The tetracarboxylic acid component and the diamine component as described above may easily provide a film having excellent mechanical properties, high rigidity and excellent dimensional stability, which may be suitably used as various substrate, including a substrate for a circuit board.

In addition, tetracarboxylic acid component(s) and diamine component(s) other than the above-mentioned components may be used, as long as the characteristics of the present invention would not be impaired.

A polyimide precursor may be synthesized by random-polymerizing or block-polymerizing substantially equimolar amounts of a tetracarboxylic acid component such as aromatic tetracarboxylic dianhydrides and a diamine component such as aromatic diamines in an organic solvent. Alternatively, two or more polyimide precursors in which either of these two components is excessive may be prepared, and subsequently, these polyimide precursor solutions may be combined and then mixed under the reaction conditions. The polyimide precursor solution thus obtained may be used without any treatment, or alternatively, after removing or adding a solvent, if necessary, to prepare a self-supporting film.

Examples of an organic solvent for the polyimide precursor solution include N-methyl-2-pyrrolidone, N,N-dimethylformamide, N,N-dimethylacetamide and N,N-diethylacetamide. These organic solvents may be used alone or in combination of two or more.

In the case of thermal imidization, the polyimide precursor solution may contain an imidization catalyst, an organic phosphorous-containing compound, an inorganic fine particle, and the like, as necessary. In the case of chemical imidization, the polyimide precursor solution may contain a cyclization catalyst and a dehydrating agent, and an inorganic fine particle, and the like, as necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, and aromatic hydrocarbon compounds or aromatic heterocyclic compounds having a hydroxyl group. Specific examples of the imidization catalyst to be suitably used include lower-alkyl imidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst to be used is preferably about 0.01 to 2 equivalents, particularly preferably about 0.02 to 1 equivalents relative to the amide acid unit in the polyamide acid. When an imidization catalyst is used, the polyimide film obtained may have improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

In the case of chemical imidization, examples of the cyclization catalyst include aliphatic tertiary amines such as trimethylamine and triethylenediamine, aromatic tertiary amines such as dimethylaniline, and heterocyclic tertiary amines such as isoquinoline, pyridine, α-picoline and β-picoline. The amount of the cyclization catalyst to be used is preferably 0.1 mole or more per mole of amic acid bond present in the aromatic polyamic acid contained in the solution.

In the case of chemical imidization, examples of the dehydrating agent include aliphatic carboxylic anhydrides such as acetic anhydride, propionic anhydride and butyric anhydride, and aromatic carboxylic anhydrides such as benzoic anhydride. The amount of the dehydrating agent to be used is preferably 0.5 mole or more per mole of amic acid bond present in the aromatic polyamic acid contained in the solution.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles may be homogeneously dispersed using the known means.

(Self-Supporting Film)

A self-supporting film of a polyimide precursor solution may be prepared by

flow-casting a solution of a polyimide precursor in an organic solvent, or a polyimide precursor solution composition which is prepared by adding an imidization catalyst, an organic phosphorous-containing compound, an inorganic fine particle, and the like to the solution, as described above, on a support; and then

heating and drying the solution or the composition to the extent that a self-supporting film is formed (which means a stage before a common curing process), for example, to the extent that the film may be peeled from the support.

The polyimide precursor solution may preferably contain the polyimide precursor in an amount of from about 10 wt % to about 30 wt %. The polyimide precursor solution may preferably have a polymer concentration of about 8 wt % to about 25 wt %.

The heating temperature and the heating time may be appropriately determined. In the case of thermal imidization, a polyimide precursor solution in the form of a film may be heated at a temperature of from 100° C. to 180° C. for about 1 min to 60 min, for example. In the case of chemical imidization, a polyimide precursor solution in the form of a film may be heated at a temperature of from 40° C. to 200° C., for example, until the film becomes self-supporting.

A smooth substrate may be suitably used as the support. A stainless substrate or a stainless belt may be used as the support, for example. An endless substrate such as an endless belt may be suitably used for continuous production.

There are no particular restrictions to the self-supporting film, so long as the solvent is removed from the film and/or the film is imidized to the extent that the film may be peeled from the support. In the case of thermal imidization, it is preferred that a weight loss on heating of a self-supporting film is within a range of 20 wt % to 50 wt %, and it is further preferred that a weight loss on heating of a self-supporting film is within a range of 20 wt % to 50 wt % and an imidization rate of a self-supporting film is within a range of 8% to 55% for the reason that the self-supporting film may have sufficient mechanical properties, and a coupling agent solution may be more evenly and more easily applied to the surface of the self-supporting film, and therefore no foaming, flaws, crazes, cracks and fissures are observed in the polyimide film obtained after imidization.

The weight loss on heating of a self-supporting film as described above is calculated by the following formula from the weight of the self-supporting film (W1) and the weight of the film after curing (W2).

Weight loss on heating (wt %)={(W1−W2)/W1}×100

The imidization rate of a self-supporting film as described above may be calculated based on the ratio of the vibration band peak area or height measured with an IR spectrometer (ATR) between the self-supporting film and the fully-cured product. The vibration band peak utilized in the procedure may be a symmetric stretching vibration band of an imide carbonyl group and a stretching vibration band of a benzene ring skeleton. The imidization rate may be also determined in accordance with the procedure described in JP-A-H09-316199, using a Karl Fischer moisture meter.

According to the present invention, a solution of a surface treatment agent such as a coupling agent and a chelating agent may be applied to one side or both sides of the self-supporting film thus obtained, if necessary.

Examples of the surface treatment agent include surface treatment agents that improve adhesiveness or adherence, and include various coupling agents and chelating agents such as a silane-based coupling agent, a borane-based coupling agent, an aluminium-based coupling agent, an aluminium-based chelating agent, a titanate-based coupling agent, a iron-based coupling agent, and a copper-based coupling agent. When using a coupling agent such as a silane coupling agent as a surface treatment agent, the more remarkable effect may be achieved.

Examples of the silane-based coupling agent include epoxysilane-based coupling agents such as γ-glycidoxypropyl trimethoxy silane, γ-glycidoxypropyl diethoxy silane, and β-(3,4-epoxycyclohexyl)ethyl trimethoxy silane; vinylsilane-based coupling agents such as vinyl trichloro silane, vinyl tris(β-methoxy ethoxy) silane, vinyl triethoxy silane, and vinyl trimethoxy silane; acrylsilane-based coupling agents such as γ-methacryloxypropyl trimethoxy silane; aminosilane-based coupling agents such as N-β-(aminoethyl)-γ-aminopropyl trimethoxy silane, N-β-(aminoethyl)-γ-aminopropylmethyl dimethoxy silane, γ-aminopropyl triethoxy silane, and N-phenyl-γ-aminopropyl trimethoxy silane; γ-mercaptopropyl trimethoxy silane, and γ-chloropropyl trimethoxy silane. Examples of the titanate-based coupling agent include isopropyl triisostearoyl titanate, isopropyl tridecyl benzenesulfonyl titanate, isopropyl tris(dioctyl pyrophosphate) titanate, tetraisopropyl bis(dioctyl phosphate) titanate, tetra(2,2-diallyloxymethyl-1-butyl) bis(di-tridecyl)phosphate titanate, bis(dioctyl pyrophosphate) oxyacetate titanate, bis(dioctyl pyrophosphate)ethylene titanate, isopropyl trioctanoyl titanate, and isopropyl tricumyl phenyl titanate.

The coupling agent may be preferably a silane-based coupling agent, particularly preferably an aminosilane-based coupling agents such as γ-aminopropyl-triethoxy silane, N-β-(aminoethyl)-γ-aminopropyl-triethoxy silane, N-(aminocarbonyl)-γ-aminopropyl triethoxy silane, N[β-(phenylamino)-ethyl]-γ-aminopropyl triethoxy silane, N-phenyl-γ-aminopropyl triethoxy silane, and N-phenyl-γ-aminopropyl trimethoxy silane. Among them, N-phenyl-γ-aminopropyl trimethoxy silane is particularly preferred.

Examples of the solvent for the solution of a surface treatment agent such as a coupling agent and a chelating agent include those listed as the organic solvent for the polyimide precursor solution (the solvent contained in the self-supporting film). The organic solvent may be a solvent which is compatible with the polyimide precursor solution, or a poor solvent which is not compatible with the polyimide precursor solution. The organic solvent may be a mixture of two or more compounds.

The content of the surface treatment agent (e.g. a coupling agent and a chelating agent) in the organic solvent solution may be preferably 0.5 wt % or more, more preferably 1 wt % to 100 wt %, particularly preferably 3 wt % to 60 wt %, further preferably 5 wt % to 55 wt %. The content of water may be preferably 20 wt % or less, more preferably 10 wt % or less, particularly preferably 5 wt % or less. A solution of a surface treatment agent in an organic solvent may preferably have a rotational viscosity (solution viscosity measured with a rotation viscometer at a temperature of 25° C.) of 0.8 to 50,000 centipoise.

A particularly preferable solution of a surface treatment agent in an organic solvent may comprise a surface treatment agent, which is homogeneously dissolved in an amide solvent, in an amount of 0.5 wt % or more, particularly preferably 1 wt % to 60 wt %, further preferably 3 wt % to 55 wt %, and have a low viscosity (specifically, rotational viscosity: 0.8 to 5,000 centipoise).

The amount of the surface treatment agent solution to be applied may be appropriately determined, and may be preferably 1 g/m² to 50 g/m², more preferably 2 g/m² to 30 g/m², particularly preferably 3 g/m² to 20 g/m², for example. The amount of the surface treatment agent solution to be applied to one side may be the same as, or different from the amount of the surface treatment agent solution to be applied to the other side.

The solution of the surface treatment agent may be applied by any known method, including, for example, gravure coating, spin coating, silk screen coating, dip coating, spray coating, bar coating, knife coating, roll coating, blade coating, and die coating.

<Second Step>

The self-supporting film obtained in the first step as described above is heated in a heating oven, to provide a polyimide film. In the heating oven, the self-supporting film is generally conveyed, while fixing both edges of the self-supporting film in the width direction with fixing members. As described above, a surface treatment agent solution is applied on the self-supporting film, as necessary.

The temperature profile of the heat treatment for imidization may be appropriately set depending on the desired properties of the polyimide film. According to the present invention, however, the temperature of the inlet of the heating oven is 180° C. or higher, in other words, the heating-starting temperature is 180° C. or higher. In the heat treatment for imidization, the self-supporting film may be preferably heated gradually for about 0.05 hr to about 5 hr under the conditions where the heating temperature is within a range of from 180° C. to 600° C., for example. The solvent and the like is sufficiently removed from the self-supporting film, while fully imidizing the polymer constituting the film, such that the polyimide film finally obtained may preferably have a volatile content (the amount of the organic solvent, water which has formed, and the like) of 1 wt % or less.

The heating zone may preferably have a temperature gradient, and may comprise a plurality of blocks having various heating temperatures. One example is that the self-supporting film is heated at a temperature of 180° C. to 220° C. as the first heat treatment; and then heated at a temperature of 220° C. to 400° C. as the second heat treatment; and then, as necessary, heated at a temperature of 400° C. to 600° C. as the third high-temperature heat treatment. In view of the residence time (heating time), one example is that the self-supporting film is heated at a temperature of 180° C. to 220° C. for 30 min or less, excluding 0, as the first heat treatment; and then heated at a high temperature of 220° C. to 400° C. for about 0.25 min to about 30 min as the second heat treatment; and then, as necessary, heated at a high temperature of 400° C. to 600° C. as the third high-temperature heat treatment. The residence time in the first heat treatment, or the time period for which the self-supporting film is heated at a temperature of 180° C. to 220° C. may be preferably 30 min or less, excluding 0, and may be preferably 2 min or less, excluding 0, more preferably 1 min or less, excluding 0, particularly preferably from 0.25 min to 1 min, in view of mass production.

The above-mentioned heat treatment may be conducted using any known heating apparatus such as a hot-air oven and an infrared oven. The film may be preferably heated at an initial heating temperature, an intermediate heating temperature and/or a final heating temperature, for example, in an inert gas atmosphere such as nitrogen gas and argon gas or in a heated gas atmosphere such as air.

According to the present invention, in the heat treatment for imidization, the temperature of the inlet of the heating oven is 180° C. or higher, as described above, and the self-supporting film is heated without changing the distance between the fixing members at both edges of the film in at least a portion of the temperature range of from 180° C. to 220° C. in the heating oven, in other words, in at least a portion of the first heat treatment in the above-mentioned example. In other words, according to the present invention, the initial heating temperature for the self-supporting film is set at a temperature higher than usual, and the self-supporting film is heated without changing the distance between the fixing members at both edges of the film in the initial heating step. The time period for which the self-supporting film is heated without changing the distance between the fixing members at both edges of the film may be preferably 30 min or less, excluding 0, and may be preferably 2 min or less, excluding 0, more preferably 1 min or less, excluding 0, particularly preferably from 0.25 min to 1 min, in view of mass production.

As a result, there may be provided a polyimide film having a strength of orientation anisotropy lower than ever. Additionally, the slanting warping may be reduced in a laminate wherein another material such as metal is laminated on the polyimide film. Although the cause of the effect is not clearly explained, it is assumed as follows. In general, the strength of orientation anisotropy is small in the middle of the polyimide film, while the strength of orientation anisotropy is greater at the edge of the film, one of the causes of which is bowing phenomenon. It is assumed that bowing phenomenon is reduced, and therefore the orientation angle at the edge of the film is reduced when the curing temperature pattern (temperature profile of the heat treatment for imidization) is changed such that the initial heating temperature for the self-supporting film is higher than ever, and the self-supporting film is heated without changing the distance between the fixing members at both edges of the film in the initial heating step as in the present invention.

The term “without changing the distance between the fixing members” as used herein means that the film is not intentionally stretched in the lateral direction (i.e. width direction) and the length of the width of the self-supporting film in the lateral direction does not substantially change. The present invention includes a case where the distance between the fixing members slightly changes due to mechanical error, which may occur.

The term “at least a portion of the temperature range of from 180° C. to 220° C.” includes a case of the whole temperature range of from 180° C. to 220° C. and a case of a portion of the temperature range of from 180° C. to 220° C. both. In the case of a portion of the temperature range, the self-supporting film may be preferably heated without changing the distance between the fixing members at both edges of the film at least in a zone close to the inlet of the heating oven (temperature: 180° C. or higher), specifically, a zone between the inlet of the heating oven and the point where the temperature reaching 200° C. in the heating oven.

In the present invention, it is particularly preferred that the self-supporting film is heated without changing the distance between the fixing members at both edges of the film throughout the temperature range of from 180° C. to 220° C. in the heating oven, which extends from the inlet of the heating oven.

The self-supporting film may be heated as described above, for example, after the film is heated without changing the distance between the fixing members at both edges of the film in at least a portion of the temperature range of from 180° C. to 220° C. in the heating oven. During the heat treatment, the film may be stretched in the machine-transport direction (hereinafter, also referred to as “MD” and “longitudinal direction”) and/or in the direction orthogonal to the machine-transport direction, i.e. in the width direction (hereinafter, also referred to as “TD” and “lateral direction”).

According to the present invention, during the heat treatment for imidization, the self-supporting film may be preferably stretched at least in the width direction in the heating step except the initial heating step, preferably in the temperature range of higher than 220° C. in the heating oven, such that the coefficient of thermal expansion of the obtained polyimide film is controlled to be within a desired range. The self-supporting film may be stretched in the longitudinal direction, as necessary.

The total stretch ratio in the TD direction, or in the TD direction and the MD direction is related to the coefficient of thermal expansion, and therefore may be appropriately selected so as to achieve a desired coefficient of thermal expansion. The total stretch ratio may be, for example, within a range of from 1.01 to 1.07, preferably from 1.01 to 1.03.

The stretch ratio (total stretch ratio) as used herein is defined as follows.

Stretch ratio (%)=(A−B)/B×100

wherein A represents the length in the width direction of the polyimide film produced after stretching, and B represents the length in the width direction of the self-supporting film before stretching.

As for the pattern of the stretching, the self-supporting film may be instantaneously stretched, or stretched step-by-step, or gradually stretched at a variable rate, or gradually stretched at a constant rate to the desired stretch ratio, or a combination of two or more of these patterns may be also employed. The self-supporting film may be preferably stretched gradually at a constant rate. The rate may be changed between different temperature ranges. In the above-mentioned example, for example, the stretch ratio may be changed between the temperature range of from 220° C. to 400° C. as the second heat treatment and the temperature range of from 400° C. to 600° C. as the third high-temperature heat treatment.

The heat treatment and the stretching in the second step (curing step) is preferably conducted by stretching the self-supporting film at least in the width direction, while continuously conveying the film by means of a tentering machine in a curing oven which comprises certain heating zones.

Any tentering machine may be used, so long as it may convey the self-supporting film while fixing both edges of the film in the width direction during the heat treatment. A pin tenter having piercing pins as film-fixing members, or a clip tenter and a chuck tenter which fix both edges of the self-supporting film with clips and chucks, respectively, may be used, for example.

The stretch ratio is determined by the ratio of enlargement of the distance between the film-fixing members (piercing pins etc.) to fix the film at both edges of the film in the width direction. According to the present invention, the amount of enlargement of the distance between the film-fixing members to fix the film at both edges of the film is substantially zero in at least a portion of the temperature range of from 180° C. to 220° C. in the heating oven, preferably throughout the whole temperature range of from 180° C. to 220° C. in the heating oven, and the distance between the fixing members is enlarged in the subsequent range.

The polyimide film of the present invention may be produced in the form of a long film by the production process as described above. Generally, the both edges of the polyimide film in the width direction, which were fixed by the tentering machine in the stage of self-supporting film, are cut off, and the resulting long polyimide film is wound into a roll and stored until subjected to the subsequent processing.

According to the present invention, there may be provided a long polyimide film wherein any strength of orientation anisotropy in the film length (length in the lateral direction, or in the width direction) of 2000 mm is 1.2 or less. And furthermore, there may be provided a long polyimide film having a lower strength of orientation anisotropy wherein any strength of orientation anisotropy in the film length (length in the lateral direction, or in the width direction) of 1800 mm is 1.1 or less. Additionally, there may be provided a long polyimide film wherein any strength of orientation anisotropy in the film length of 2000 mm is 1.2 or less and any strength of orientation anisotropy in the film length of 1800 mm within the polyimide film having a length of 2000 mm is 1.1 or less.

The term “any strength of orientation anisotropy in the film length of 2000 mm is 1.2 or less” as used herein means that any strength of orientation anisotropy at any point in the film length of 2000 mm is 1.2 or less. The term “any strength of orientation anisotropy in the film length of 1800 mm is 1.1 or less” as used herein means that any strength of orientation anisotropy at any point in the film length of 1800 mm is 1.1 or less.

The preferable materials for producing such a polyimide film may be 3,3′,4,4′-biphenyltetracarboxylic dianhydride as the tetracarboxylic acid component and p-phenylenediamine as the diamine component.

The thickness of the polyimide film may be appropriately selected and may be, but not limited to, 125 μm or less, preferably from 5 μm to 75 μm, more preferably from 6 μm to 50 μm, more preferably from 7 μm to 35 μm, particularly preferably from 7 μm to 13 μm.

The present invention is not limited to a single-layer polyimide film, which is mainly described in the aforementioned. The present invention may be applied, for example, to a multi-layer polyimide film prepared by heating a self-supporting film as described above on which a a-BPDA/DADE polyamic acid solution is applied, and a thermo-compression bondable multi-layer film.

The polyimide film may have a coefficient of thermal expansion in the TD direction (CTE−TD) which is close to the coefficient of thermal expansion in the MD direction (CTE−MD). The absolute value of the difference between (CTE−MD) and (CTE−TD) may preferably satisfy the inequality:

[(CTE−MD)−(CTE−TD)]<5 ppm/° C.,

and more preferably satisfy the inequality:

[(CTE−MD)−(CTE−TD)]<4 ppm/° C.,

and particularly preferably satisfy the inequality:

[(CTE−MD)−(CTE−TD)]<2 ppm/° C.

A polyimide film produced according to the present invention may be suitably used as a base film for a circuit board, a base film for a flexible wiring board, a base film for a solar cell, and a base film for an organic EL, and particularly suitably used as a base film for a circuit board, and a base film for a flexible wiring board.

<Laminate Comprising Polyimide Film>

A metal may be laminated on a polyimide film which is prepared according to the present invention, to provide a laminate. A polyimide film which is prepared according to the present invention may have improved adhesiveness, sputtering properties, and metal vapor deposition properties. Therefore, a metal foil such as a copper foil may be attached onto the polyimide film with an adhesive, or alternatively, a metal layer such as a copper layer may be formed on the polyimide film by a metallizing method such as sputtering and metal vapor deposition, to provide a metal-laminated polyimide film such as a copper-laminated polyimide film having excellent adherence and sufficiently high peel strength. A polyimide film which is prepared according to the present invention may be more suitably used for the formation of a metal layer such as a copper layer thereon by a metallizing method such as sputtering and metal vapor deposition, in particular. In addition, a metal foil such as a copper foil may be laminated on a polyimide film which is prepared according to the present invention, using a thermocompression-bondable polymer such as a thermocompression-bondable polyimide, to provide a metal foil-laminated polyimide film. A metal layer may be laminated on a polyimide film by a known method.

The type and thickness of the metal foil, which is attached onto the polyimide film via an adhesive, may be appropriately selected depending on the intended use. Specific examples of the metal foil include a rolled copper foil, an electrolytic copper foil, a copper alloy foil, an aluminum foil, a stainless foil, a titanium foil, an iron foil and a nickel foil. The thickness of the metal foil may be preferably from about 1 μm to about 50 μm, more preferably from about 2 μm to about 20 μm.

Another resin film, a metal such as copper, a chip member such as an IC chip, or the like may be attached directly, or via an adhesive onto a polyimide film which is prepared according to the present invention.

Any known adhesive, including an adhesive having excellent insulating properties and excellent adhesion reliability, or an adhesive having excellent conductivity and excellent adhesion reliability such as an ACF, which is bonded by pressure, may be used depending on the intended use. Specific examples of the adhesive include thermoplastic adhesives and thermosetting adhesives.

Examples of the adhesive include polyimide adhesives, polyamide adhesives, polyimide-amide adhesives, acrylic adhesives, epoxy adhesives, urethane adhesives, and adhesives containing two or more thereof. An acrylic adhesive, an epoxy adhesive, a urethane adhesive, or a polyimide adhesive may be particularly suitably used.

The metallizing method is a method for forming a metal layer, which is different from metal plating and metal foil lamination, and any known method such as vacuum vapor deposition, sputtering, ion plating and electron-beam evaporation may be employed.

Examples of the metal to be used in the metallizing method include, but not limited to, metals such as copper, nickel, chromium, manganese, aluminum, iron, molybdenum, cobalt, tungsten, vanadium, titanium and tantalum, and alloys thereof, and metal compounds such as oxides and carbides of these metals. The thickness of the metal layer formed by a metallizing method may be appropriately selected depending on the intended use, and may be preferably from 1 nm to 500 nm, more preferably from 5 nm to 200 nm for a practical use. The number of metal layers formed by a metallizing method may be appropriately selected depending on the intended use, and may be one, two, multi such as three or more layers.

A metal-plated layer such as a copper-plated layer and a tin-plated layer may be formed by a known wet plating process such as electrolytic plating and electroless plating on the surface of the metal layer of the metal-laminated polyimide film, which is produced by a metallizing method. The thickness of the metal-plated layer such as a copper-plated layer may be preferably from 1 μm to 40 μm for a practical use.

### EXAMPLES

The present invention will be described in more detail below with reference to the Examples. However, the present invention is not limited to these Examples.

The properties as described below were evaluated as follows.

### (1) Method of Measuring the Weight Loss on Heating of a Self-Supporting Film

A self-supporting film was heated at 480° C. for 5 min in an oven. The weight loss on heating was calculated from the weight of the film before the heat treatment (W1) and the weight of the film after the heat treatment (W2) by the following formula.

Weight loss on heating (%)=(W1−W2)/W1×100

### (2) Method of Measuring the Imidization Rate of a Self-Supporting Film

ATR-IR spectra of a self-supporting film and the fully-imidized film thereof were measured with a ZnSe, using FT-IR-4100 made by Jasco Corporation. The maximum value of the peak around 1772 cm⁻¹ was taken as X1, and the maximum value of the peak around 1517 cm⁻¹ was taken as X2. The imidization rate of the self-supporting film was calculated from the area ratio (X1/X2) of the self-supporting film and the area ratio (X1/X2) of the fully-imidized film by the following formula. The measurements of the self-supporting film were carried out on both sides of the films, and an average value of the both sides was defined as the imidization rate. The fully-imidized film to be measured was prepared by heating the self-supporting film at 480° C. for 5 min. The support side when the polyimide precursor solution was cast on the support was taken as side A of the film, while the gas side was taken as side B of the film.

Imidization rate (%)=(a1/a2+b1/b2)×50

wherein
X1 represents the maximum value of the peak around 1772 cm⁻¹;
X2 represents the maximum value of the peak around 1517 cm⁻¹;
a1 represents the area ratio (X1/X2) of side A of the self-supporting film;
b1 represents the area ratio (X1/X2) of side B of the self-supporting film;
a2 represents the area ratio (X1/X2) of side A of the fully-imidized film; and
b2 represents the area ratio (X1/X2) of side B of the fully-imidized film.

### Example 1

Into a polymerization tank were placed the predetermined amount of N,N-dimethylacetamide, and then equimolar amounts of 3,3′,4,4′-biphenyltetracarboxylic dianhydride (99.95 mol % in terms of all acid dianhydride) and p-phenylenediamine (100 mol % in terms of all diamine). The resulting mixture was mixed, to provide a polyimide precursor solution (polyamic acid solution) having a polymer concentration of 18 wt % and a solution viscosity (measurement temperature: 30° C.) of 1800 poise. To the polyimide precursor solution was added 0.05 mole of 1,2-dimethylimidazole as an imidization catalyst per mole of the polyamic acid contained in the polyimide precursor solution. And then, the mixture was stirred at a temperature of 30° C. for 2 hours.

The polyimide precursor solution composition thus obtained was continuously flow-cast from a slit of a T-die mold on a stainless support in the form of endless belt in a drying oven, to form a thin film on the support. The thin film was dried at a temperature of from 120° C. to 140° C., while controlling the temperature and the heating time, to provide a long self-supporting film having a weight loss on heating (solvent content) of 34% and a imidization rate of 11%.

Subsequently, the self-supporting film was fed into a continuous heating oven (curing oven) by means of a tentering machine, while fixing both edges of the film in the width direction with piercing pins. In the continuous heating oven, the temperature was set to rise step by step from the inlet to the outlet. In the heating oven, the self-supporting film was heated under the conditions of “190° C.×0.5 min-230° C.×0.5 min-270° C.×0.5 min”. During the heat treatment, except for 1z (zone) as shown in Table 1, the film was stretched as shown in Table 1 by enlarging the distance between the fixing members to fix both edges of the films in the width direction. During the heat treatment at 190° C. for 0.5 min (1z (zone) as shown in Table 1), the film was heated without changing the distance between the pins as film-fixing members, in other words, without stretching the film by force. After the heat treatment at 270° C. for 0.5 min, the self-supporting film was further heated under the conditions of “350° C.×1.0 min-500° C.×1.0 min”, and then cooled down to room temperature in 2 min. The stretch ratio in the width direction at 350° C. was 102.3, and the stretch ratio in the width direction at 500° C. was 102.9. Subsequently, the film was heated under the conditions of “500° C.×2 min” without stretching the film to complete imidization, thereby continuously producing a long polyimide film having an average thickness of 12.5 μm and a width (length in the width direction of the film) of 2200 mm.

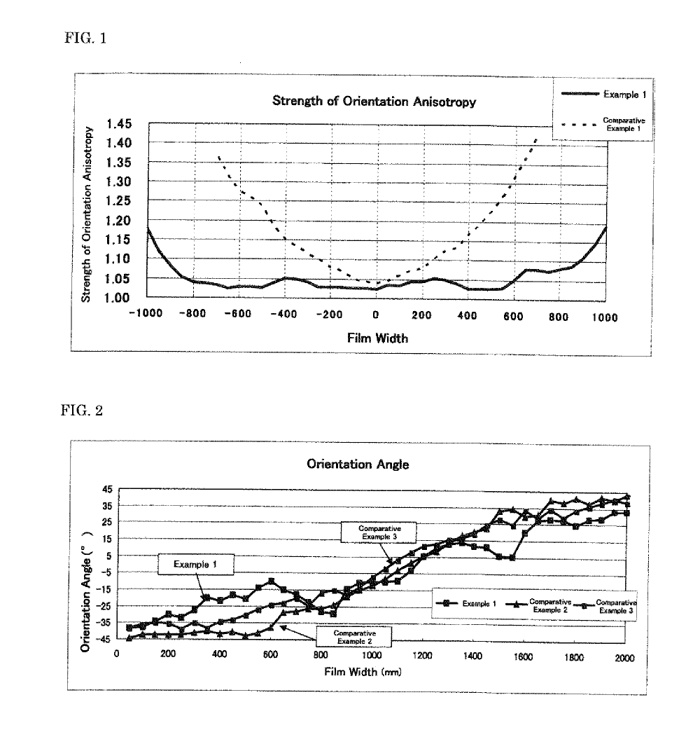

The strength of orientation anisotropy in the polyimide film thus obtained was measured as follows. The speed of sound in every direction in the film plane was measured at 41 locations at intervals of 5 cm in the width direction, using an orientation tester “SST-4000” made by NOMURA SHOJI Co., Ltd., and the ratio of the maximum value to the minimum value was defined as the strength of orientation anisotropy. The results are shown in FIG. 1. The measurement results revealed that the strength of orientation anisotropy in the film width of 2000 mm was reduced and 1.2 or less.

The orientation angle in the polyimide film thus obtained was measured. More specifically, the orientation angle was measured at 41 locations at intervals of 5 cm in the width direction, using a birefringence analyzer with sample feed “KOBRA-WFDO” made by Oji Scientific Instruments, in wavelength-decentralization mode at wavelengths of 450, 500, 550, 590, 630 and 750 nm. The results are shown in FIG. 2. The slope of orientation angle in the polyimide film of Example 1 was reduced.

The coefficient of thermal expansion (50° C. to 200° C.) of the polyimide film thus obtained was measured by a thermo-mechanical analyzer (TMA) (tensile mode; load: 4 g; distance between chucks: 15 mm; temperature-increasing rate: 20° C./min), using a sample which had been heated at 300° C. for 30 min for stress relaxation. The results revealed that the average of coefficients of thermal expansion of the polyimide film, which were measured at 5 locations in the width direction, was MD 10.7 ppm/° C. and TD 8.9 ppm/° C.

A copper-laminated polyimide film as a laminate was produced by laminating copper on the polyimide film prepared in the Example 1 by sputtering. The copper-laminated polyimide film thus obtained had no slanting warping observed. In addition, dimensional accuracy in processing did not deteriorate.

And besides, in the Example 1, after the heat treatment at 270° C. for 0.5 min, the self-supporting film was further heated under the conditions of “350° C.×1.0 min (stretch ratio in the width direction: 102.3)−500° C.×1.0 min (stretch ratio in the width direction: 102.9)”, and then heated under the conditions of “500° C.×2 min” without stretching the film to complete imidization. Subsequently, the film was cooled down to room temperature in 2 min, thereby producing a long polyimide film having an average thickness of 12.5 μm and a width (length in the width direction of the film) of 2200 mm. In the polyimide film thus obtained, the strength of orientation anisotropy in the film width of 2000 mm was reduced and 1.2 or less. The slope of orientation angle in the polyimide film was reduced. Moreover, the copper-laminated polyimide film which was prepared using the polyimide film had no slanting warping observed. In addition, dimensional accuracy in processing did not deteriorate.

### Comparative Example 1

The self supporting film which was prepared in the same way as in Example 1 was heated under the conditions of “110° C.×0.5 min-140° C.×0.5 min-180° C.×0.5 min”. During the heat treatment, the film was stretched as shown in Table 1 by enlarging the distance between the fixing members to fix both edges of the films in the width direction. After the heat treatment at 180° C. for 0.5 min, the self supporting film was further heated under the conditions of “350° C.×1.0 min (stretch ratio in the width direction: 102.3)−500° C.×1.0 min (stretch ratio in the width direction: 102.9)”, and then cooled down to room temperature in 2 min, thereby continuously producing a long polyimide film having an average thickness of 12.5 μm a width of 2200 mm.

The strength of orientation anisotropy in the polyimide film thus obtained was measured in the same way as in Example 1. The results are shown in FIG. 1. In the polyimide film of Comparative Example 1 in which the temperature of the inlet of the heating oven was relatively low, the strength of orientation anisotropy was greater and greater toward both edges of the film. Meanwhile, the average of coefficients of thermal expansion of the polyimide film, which were measured at 5 locations in the width direction, was MD 10.6 ppm/° C. and TD 9.3 ppm/° C.

A copper-laminated polyimide film was produced by laminating copper on the polyimide film prepared in the Comparative Example 1 by sputtering. The copper-laminated polyimide film thus obtained had slanting warping observed.

### Comparative Example 2

The self-supporting film which was prepared in the same way as in Example 1 was heated under the conditions of “170° C.×0.5 min-200° C.×0.5 min-240° C.0.5 min”. During the heat treatment, the film was stretched as shown in Table 1 by enlarging the distance between the fixing members to fix both edges of the films in the width direction. After the heat treatment at 240° C. for 0.5 min, the self-supporting film was further heated under the conditions of “350° C.×1.0 min (stretch ratio in the width direction: 102.3)−500° C.×1.0 min (stretch ratio in the width direction: 102.9)”, and then cooled down to room temperature in 2 min, thereby continuously producing a long polyimide film having an average thickness of 12.5 μm and a width of 2200 mm.

The orientation angle in the polyimide film thus obtained was measured in the same way as in Example 1. The results are shown in FIG. 2. The slope of orientation angle was greater near both edges of the film, in particular. Meanwhile, the average of coefficients of thermal expansion of the polyimide film, which were measured at 5 locations in the width direction, was MD 10.0 ppm/° C. and TD 7.7 ppm/° C.

A copper-laminated polyimide film was produced by laminating copper on the polyimide film prepared in the Comparative Example 2 by sputtering. The copper-laminated polyimide film thus obtained had slanting warping observed.

### Comparative Example 3

The self-supporting film which was prepared in the same way as in Example 1 was heated under the conditions of “190° C.×0.5 min-230° C.×0.5 min-270° C.×0.5 min”. During the heat treatment, the film was stretched as shown in Table 1 by enlarging the distance between the fixing members to fix both edges of the films in the width direction. After the heat treatment at 270° C. for 0.5 min, the self-supporting film was further heated under the conditions of “350° C.×1.0 min (stretch ratio in the width direction: 102.3)−500° C.×1.0 min (stretch ratio in the width direction: 102.9)”, and then cooled down to room temperature in 2 min, thereby continuously producing a long polyimide film having an average thickness of 12.5 μm and a width of 2200 mm.

The orientation angle in the polyimide film thus obtained was measured in the same way as in Example 1. The results are shown in FIG. 2. The slope of orientation angle was greater near both edges of the film, in particular. Meanwhile, the average of coefficients of thermal expansion of the polyimide film, which were measured at 5 locations in the width direction, was MD 10.5 ppm/° C. and TD 9.1 ppm/° C.

A copper-laminated polyimide film was produced by laminating copper on the polyimide film prepared in the Comparative Example 3 by sputtering. The copper-laminated polyimide film thus obtained had slanting warping observed.

TABLE 1

| | | Ex- | Comparative | Comparative | Comparative |
|---|---|---|---|---|---|
| | | ample 1 | Example 1 | Example 2 | Example 3 |
| Tem- | 1Z(° C.) | 190 | 110 | 170 | 190 |
| perature | 2Z(° C.) | 230 | 140 | 200 | 230 |
| | 3Z(° C.) | 270 | 180 | 240 | 270 |
| Stretch | Inlet | 100.0 | 100.5 | 100.5 | ← |
| ratio | 1z | 100.0 | 101.3 | 101.3 | ← |
| | 2z | 101.0 | 102.2 | 101.8 | ← |
| | 3z | 101.3 | 102.8 | 102.4 | ← |

### INDUSTRIAL APPLICABILITY

As described above, according to the present invention, there may be provided a polyimide film, particularly a wide polyimide film, on which another material such as metal is laminated to provide a laminate having an improved slanting warping. The polyimide film of the present invention may be suitably used as a base film for a circuit board, a base film for a flexible wiring board, and the like.

1. A process for producing a polyimide film, comprising:
reacting a tetracarboxylic acid component and a diamine component in a solvent, to provide a polyimide precursor solution;
flow-casting the polyimide precursor solution on a support;
drying the solution to form a self-supporting film; and
heating the self-supporting film in a heating oven while fixing both edges of the film in the width direction with fixing members, to provide a polyimide film; wherein
the temperature of the inlet of the heating oven is 180° C. or higher; and
the self-supporting film is heated without changing the distance between the fixing members at both edges of the film in at least a portion of the temperature range of from 180° C. to 220° C. in the heating oven; and then
the self-supporting film is stretched in the width direction by changing the distance between the fixing members at both edges of the film in at least a portion of the temperature range of higher than 220° C. in the heating oven.

2. The process for producing a polyimide film as claimed in claim 1, wherein the self-supporting film is heated without changing the distance between the fixing members at both edges of the film throughout the temperature range of from 180° C. to 220° C. in the heating oven.

3. The process for producing a polyimide film as claimed in claim 1, wherein the self-supporting film is heated for 1 min or less, excluding 0 min, in the temperature range of from 180° C. to 220° C. in the heating oven.

4. The process for producing a polyimide film as claimed in claim 1, wherein the self-supporting film is heated for 1 min or less, excluding 0 min, without changing the distance between the fixing members at both edges of the film throughout the temperature range of from 180° C. to 220° C. in the heating oven.

5. A polyimide film prepared from a tetracarboxylic acid component and a diamine component, wherein the strength of orientation anisotropy in the film length of 2000 mm is 1.2 or less.

6. A polyimide film prepared from a tetracarboxylic acid component and a diamine component, wherein the strength of orientation anisotropy in the film length of 1800 mm is 1.1 or less.

7. The polyimide film as claimed in claim 5, wherein the tetracarboxylic acid component is 3,3′,4,4′-biphenyltetracarboxylic dianhydride, and the diamine component is p-phenylenediamine.

8. A laminate comprising the polyimide film as claimed in claim 5, and a metal which is laminated on the polyimide film.

9. The polyimide film as claimed in claim 6, wherein the tetracarboxylic acid component is 3,3′,4,4′-biphenyltetracarboxylic dianhydride, and the diamine component is p-phenylenediamine.

10. A laminate comprising the polyimide film as claimed in claim 6, and a metal which is laminated on the polyimide film.
